(19) United States
(12) Patent Application Publication
(10) Pub. No.: US 2007/0178353 A1
(43) Pub. Date: Aug. 2, 2007

(54) Electrode of alkaline fuel cell and method for producing thereof

(76) Inventors: Ziya Ramizovich Karichev, Moscow (RU); Jef Spaepen, Kasterlee (BE)

Correspondence Address: KNOBBE MARTENS OLSON & BEAR LLP, 2040 MAIN STREET, FOURTEENTH FLOOR, IRVINE, CA, 92614, US

(21) Appl. No.: 10/594,790

(22) PCT Filed: Mar. 30, 2005
(86) PCT No.: PCT/RU05/00151

§ 371 Date: Sep. 29, 2006

(30) Foreign Application Priority Data
Mar. 30, 2004 (RU) 2004109249

(51) Int. Cl. H01M 2/08; H01M 4/86; H01M 4/88

(52) U.S. Cl. 429/35; 429/44; 429/41; 502/101

(57) ABSTRACT

The invention relates to the field of electrical engineering and can be used in the production of electrodes for alkaline fuel cells. An object of the invention is to increase the electrode service life. According to the invention, an electrode of an alkaline fuel cell comprises an insulating frame having ports for feeding and discharging reagents, a mesh current collector embedded in the frame and having lead-outs extending beyond the frame, an active and a barrier layers sequentially applied onto the mesh current collector, wherein sites of the embedment of the current collector and the lead-outs in the insulating frame and a periphery of the current collector along an inner edge of the insulating frame are provided with a sealing layer which can be made of an electrolyte non-wettable substance, e.g. with a sealing layer made of fluoroplastic. The invention also provides a method for producing an electrode of an alkaline fuel cell, which method includes producing a mesh current collector having lead-outs, sequentially applying an active and a barrier layers onto the mesh current collector, embedding the current collector having the lead-outs into the insulating frame, wherein, before the application of the active and barrier layers onto the current collector, edges of the current collector and the lead-outs in sites of the embedment into the insulating frame are impregnated with a lacquer solution and, after the collector has been embedded into the insulating frame, a periphery of the collector along an inner edge of the insulating frame is impregnated with the lacquer solution. A solvent wetting the mesh current collector is used as a solvent for the lacquer, and a substance which forms a continuous, electrolyte non-wettable film after the solvent evaporation is used as the lacquer.

### FIELD OF THE INVENTION

The invention relates to the field of electrical engineering and can be used in the production of gas-diffusion electrodes for primary electrochemical cells (chemical current sources), for example, for hydrogen-oxygen (air) alkaline fuel cells (FC).

### BACKGROUND OF THE INVENTION

A frame-construction electrode having an insulating frame with ports for feeding and discharging working media, said ports being uniformly arranged at the periphery of said frame along the perimeter thereof, is known from the prior art (FR 2,300,425, H01M8/24, 1976).

A drawback of this electrode relates to the absence of external electrode current lead-outs extending beyond the insulating frame, which limits the possibility of electrical connecting of the FC electrodes, when assembling a module, only to a series connection using bipolar plates. Furthermore, the uniform arrangement of the ports along the whole perimeter of the insulating frames completely excludes the possibility of providing external current lead-outs from the electrodes.

Among the known gas-diffusion electrodes for alkaline FCs, a prior art closest to the present invention in respect to the combination of essential features and the technical result achieved is a FC gas-diffusion electrode comprising an insulating frame having ports for feeding and discharging working media, a mesh current collector embedded in the frame and having current lead-outs extending beyond the frame, an active and a barrier layers sequentially applied onto the current collector (the Russian Patent No. 2,183,370 C1, H01M8/04, 2002).

A drawback of the known electrode is an insufficient service life associated with an electrolyte being capable to leak out through sites of the embedment of the current collector and the lead-outs in the insulating frame. This is due to the fact that, when embedding the current collector into the frame, a material of the frame does not completely fill up cells of the mesh, and the electrolyte gradually penetrates through the unfilled mesh cells of the current collector into the embedment sites. Here, the electrolyte has a propping action in the embedment sites of the current collector and the lead-outs, which results in a seal failure in the embedment sites and a leakage of the electrolyte.

A gas-diffusion electrode production method in which an active and a barrier layers are sequentially applied by the pressing technique onto a porous current collector from a foam-like nickel is known from the prior art (the Russian Patent No. 2,044,370 C1, H10M4/96, 1995).

A drawback of said electrode production method is a high cost due to the use of an expensive current collector and to the complexity of production process.

Among the known gas-diffusion electrode production methods, a prior art closest to the present invention in respect to the combination of essential features and the technical result achieved is a gas-diffusion electrode production method in which a mesh current collector is produced, an active and a barrier layers are sequentially applied onto the mesh current collector, and the current collector having lead-outs is embedded into a frame (the Russian Patent No. 2,170,477 C1, H01M4/96, 2001).

A drawback of said electrode production method is a low service life of the produced electrodes due to the electrolyte leakage through the embedment sites of the current collector edges and the lead-outs in the frame.

### SUMMARY OF THE INVENTION

An object of the present invention is to provide a gas-diffusion electrode for an alkaline fuel cell (FC) and a method for producing thereof, which provides for the production of electrodes exhibiting an increased service life.

This object (technical result) is achieved by that an electrode of an alkaline fuel cell comprises an insulating frame having ports for feeding and discharging reagents, a mesh current collector embedded in the frame and having lead-outs extending beyond the frame, an active and a barrier layers sequentially applied onto the mesh current collector, wherein, according to the invention, sites of the embedment (sealing-in) of the current collector and the lead-outs in the insulating frame and a periphery of the current collector along an inner edge of the insulating frame are provided with a sealing layer.

Preferably, the sealing layer is made of an electrolyte non-wettable material.

Preferably, the sealing layer is made of fluoroplastic. The presence of the sealing layer from an electrolyte non-wettable material in the embedment sites of the current collector in the frame provides for a reliable (tight) sealing of the current collector and the lead-outs in the frame and prevents the electrolyte from leaking out.

As for the method for producing an electrode of an alkaline fuel cell, the above object (technical result) is achieved by that, in an electrode production method in which a mesh current collector having lead-outs is produced, an active and a barrier layers are sequentially applied onto the mesh current collector, and the current collector having the lead-outs is embedded into an insulating frame, in accordance with the invention, before the application of the active and barrier layers onto the current collector, edges of the current collector and the lead-outs in sites of the embedment into the insulating frame are impregnated with a solution of fluoroplastic lacquer and, after the collector has been embedded into the insulating frame, a periphery of the collector along an inner edge of the insulating frame is impregnated with the lacquer solution.

Preferably, a solvent wetting the mesh current collector is used as a solvent for the lacquer, and a substance which forms a continuous, electrolyte non-wettable film after the solvent evaporation is used as the lacquer. The impregnation of the embedment sites of the current collector and the lead-outs in the frame, as well as the periphery of the current collector along the inner edge of the insulating frame, with the solution of a substance forming a continuous film non-wettable with the alkaline electrolyte after the solvent evaporation allows to reliably (tightly) seal the current collector in the insulating frame and to prevent the electrolyte from leaking out.

A conducted analysis of the prior art has shown that the claimed combination of essential features present within the claims is not known. This allows to make a conclusion on its correspondence to the ‘novelty’ criterion.

In order to check up the claimed invention for the correspondence to the ‘inventive step’ criterion, an additional information search for known technical solutions has been carried out to reveal the features coinciding with that ones distinguishing the claimed technical solution over the closest prior art. It has been stated that the claimed technical solution is not obvious from the prior art. Consequently, the claimed invention meets the ‘inventive step’ criterion.

The essence of the invention is further explained by the drawings and by the embodiment of the claimed electrode production method.

### BRIEF DESCRIPTION OF THE DRAWINGS

FIG. 1 shows a mesh current collector having lead-outs.

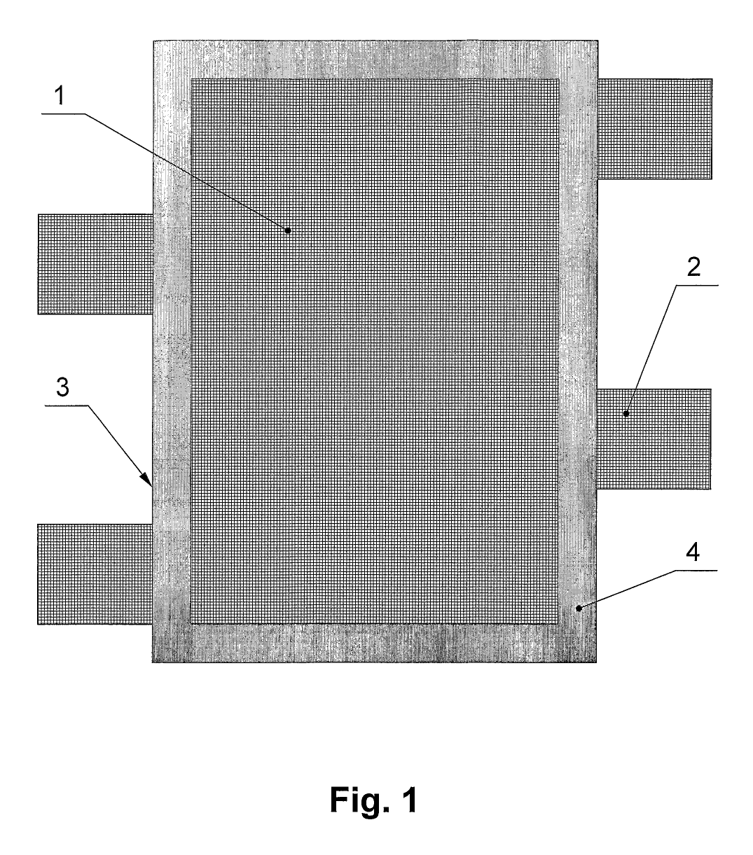

FIG. 2 shows an electrode of an alkaline fuel cell in section across an embedment site of the lead-outs.

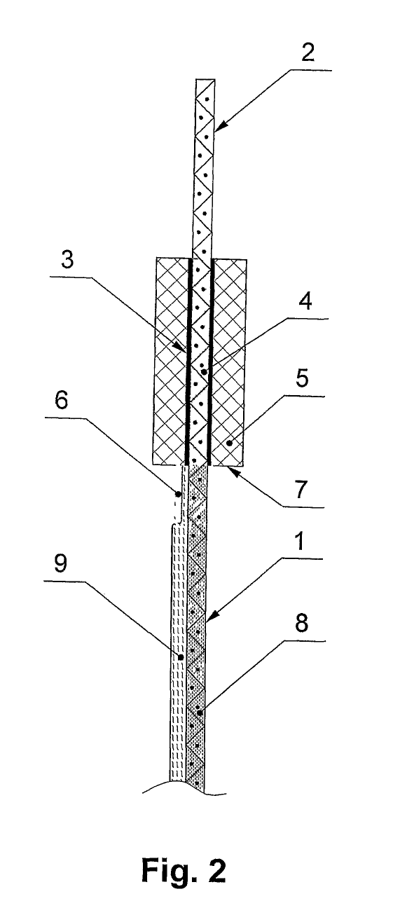

The electrode comprises a current collector 1 having current lead-outs 2, an embedment site 3, a sealing layer 4 in the site of embedment into an insulating frame 5 having ports (not shown in FIG. 2) for feeding and discharging reagents, a sealing layer 6 along an inner edge 7 of the insulating frame 5, an active layer 8, and a barrier layer 9.

### EMBODIMENT OF THE INVENTION

A 100×200 mm sized current collector having four 20×40 mm sized lead-outs were cut from a 0.4 mm thick nickel mesh having a mesh cell size of 0.05×0.05 mm. An edge of the current collector in presumptive sites of the embedment in the insulating frame was covered with a layer of a LF-32L fluoroplastic lacquer (TU6-05-1884-80), “Plastpolymer” Ltd., Russia. The current collector was subjected to drying in air for 24 hours. A composition for active layer was prepared from a mixture of 90% graphite and 10% Teflon for a hydrogen electrode and from a mixture of 67% graphite, 23% absorbent carbon (activated charcoal) and 10% Teflon for an oxygen (air) electrode. The mixture was intimately mixed and was rolled into a sheet of the predetermined thickness. An active layer of prescribed dimensions was cut from the obtained sheet. A composition for hydro-barrier layer was prepared from a mixture of 30% Teflon and 70% ammonium bicarbonate. The mixture was intimately mixed and was rolled into a sheet of the predetermined thickness. A hydro-barrier layer of prescribed dimensions was cut from the obtained sheet. The active layer and the hydro-barrier layer were sequentially stacked onto the current collector and these layers were bonded to the current collector by the pressing technique. The produced perform (blank) was embedded into an insulating frame of ABC-plastic by the cast molding technique under a pressure of 200 tons and a temperature of 220° C. The produced electrodes were covered with a layer of the lacquer in the form of a 4 mm wide strip along an inner edge of the insulating frame by the spreading technique. The thus produced hydrogen and oxygen (air) electrodes were installed into an experimental cell and were tested in air and hydrogen at a temperature of 70° C. for 1000 hours at a load current density of 50 mA/cm². There was no electrolyte leakage observed during the tests, and electrical characteristics were stable.

Based on the above mentioned, it is possible to make a conclusion that the claimed electrode and method for producing thereof can be implemented in practice while achieving the technical result mentioned above, i.e. they satisfy the ‘industrial applicability’ criterion.

1. An electrode of an alkaline fuel cell, the electrode comprising an insulating frame comprising:
a plurality of ports configured to feed and discharge reagents;
a mesh current collector embedded in the frame and having lead-outs extending beyond the frame;
an active layer and a barrier layers sequentially applied onto the mesh current collector, wherein sites of the embedment of the current collector and the lead-outs in the frame, and a periphery of the current collector along an inner edge of the frame include a sealing layer.

2. The electrode according to claim 1, wherein the sealing layer is made of an electrolyte non-wettable substance.

3. The electrode according to claim 2, wherein the sealing layer is formed from fluoroplastic.

4. A method of producing an electrode of an alkaline fuel cell, the method comprising:
producing a mesh current collector including lead-outs;
sequentially applying an active layer and a barrier layers onto the mesh current collector;
embedding the current collector into an insulating frame;
prior to the application of the active and barrier layers onto the current collector, impregnating edges of the current collector and the lead-outs in sites of the embedment into the insulating frame with a lacquer solution; and
after the embedding of the current collector into the insulating frame, impregnating a periphery of the current collector along an inner edge of the insulating frame with the lacquer solution.

5. The method according to claim 4, further comprising:
using a solvent wetting the mesh current collector as a solvent for the lacquer; and
evaporating the solvent, wherein the lacquer is substance which forms a continuous, electrolyte non-wettable film after evaporating the solvent.
